(19) United States
(12) Patent Application Publication
(10) Pub. No.: US 2025/0333048 A1
(43) Pub. Date: Oct. 30, 2025

(54) METHOD FOR CONTROLLING A VEHICLE

(71) Applicant: ZF CV Systems Global GmbH, Bern (CH)

(72) Inventors: Benjamin Bieber, Wedemark (DE); Jonas Böttcher, Hannover (DE); Klaus Plähn, Seelze (DE); Oliver Wulf, Neustadt (DE)

(21) Appl. No.: 19/264,720

(22) Filed: Jul. 9, 2025

Related U.S. Application Data
(63) Continuation of application No. PCT/EP2024/050031, filed on Jan. 2, 2024.

(30) Foreign Application Priority Data
Jan. 13, 2023 (DE) 10 2023 100 747.5

(51) Int. Cl. B60W 30/02; B60W 10/18; B60W 40/13; B60W 50/00

(52) U.S. Cl. CPC B60W 30/02; B60W 10/18; B60W 40/13; B60W 50/00; B60W 2050/0009; B60W 2300/14; B60W 2510/0657; B60W 2510/207; B60W 2520/22; B60W 2540/18; B60W 2556/10

(57) ABSTRACT

A method for controlling a vehicle in a driving situation includes: determining a trajectory of the vehicle for the driving situation; determining a target steering angle on the basis of the trajectory; determining an actual steering angle of the vehicle in the driving situation; determining a steering angle deviation between the determined target steering angle and the determined actual steering angle; providing a steering angle tolerance value for the steering angle deviation; providing early detection of instability of the vehicle when the determined steering angle deviation violates the steering angle tolerance value; and in response to the early detection of instability of the vehicle: executing at least one driving dynamics intervention using at least one vehicle actuator of the vehicle to counteract the instability of the vehicle. A driver assistance system, a vehicle and a computer program product are configured to perform the method.

### CROSS-REFERENCE TO RELATED APPLICATIONS

This application is a continuation application of international patent application PCT/EP2024/050031, filed Jan. 2, 2024, designating the United States and claiming priority from German application 10 2023 100 747.5, filed Jan. 13, 2023, and the entire content of both applications is incorporated herein by reference.

### TECHNICAL FIELD

The disclosure relates to a method for controlling a vehicle in a driving situation. Furthermore, the disclosure relates to a driver assistance system, a vehicle and a computer program product.

### BACKGROUND

An experienced professional driver can already judge on the basis of his experience whether a vehicle is behaving in a stability-critical manner. The driving style adopted by an experienced driver matches the given boundary conditions and enables the vehicle to be controlled safely. The experience necessary for correctly judging the present situation generally only results after multiple years of practice, however. Based on this experience, an experienced driver correctly assesses the vehicle's behavior and controls the vehicle safely in a given driving situation.

In contrast, an inexperienced driver cannot or can only partially correctly assess the vehicle behavior that is to be expected. Drivers referred to as “virtual drivers”, which control autonomous vehicles or perform partial tasks in the control of autonomous or semi-autonomous vehicles, have not hitherto been able to ensure correct assessment of stability behavior. This involves the risk of a driving style unsuitable for the present vehicle configuration and as a result also an increased risk of accident.

Known stability control systems only stabilize vehicles reactively if the vehicle has already clearly left a state of motion that is considered stable. A stability control system, such as Electronic Stability Control (ESC) in particular, only intervenes to stabilize the movement of the vehicle when an intervention threshold is exceeded. This intervention threshold has been set high for safety reasons in order to prevent the stability control system from intervening incorrectly. For example, ESC is usually only triggered when a driver (human or virtual) of the vehicle notices instability and tries to compensate for this by making jerky steering movements. Conventional stability control systems therefore have the disadvantage that the driver is only inadequately supported in solving a driving task to be fulfilled for the driving situation, which usually consists of guiding the vehicle along a specific path (target path). Compared to stable driving, considerably more space is required as a result of the late intervention of a conventional stability control system. Although conventional stability control systems generally control instabilities reliably, there are usually considerable deviations of the vehicle from the planned path. This results in a considerable safety risk, especially if an inexperienced driver recognizes an instability late, tries to compensate for the instability late and thus triggers the stability control system late.

### SUMMARY

It is an object of the disclosure to provide methods for controlling a vehicle, vehicle control system, vehicles and/or computer program products that enable the early detection of instabilities, which are preferably cost-effective to implement and/or offer improved safety.

In a first aspect, the disclosure solves the problem via a method for controlling a vehicle in a driving situation, including: determining a trajectory of the vehicle for the driving situation; determining a target steering angle on the basis of the trajectory; determining an actual steering angle of the vehicle in the driving situation; determining a steering angle deviation between the determined target steering angle and the determined actual steering angle; providing a steering angle tolerance value for the steering angle deviation; early detection of instability of the vehicle if the determined steering angle deviation violates the steering angle tolerance value; and in response to the early detection of instability of the vehicle: executing at least one driving dynamics intervention using at least one vehicle actuator of the vehicle in order to counteract the instability of the vehicle.

The disclosure is based on the realization that the actual steering angle in the driving situation deviates from a target steering angle in the event of instability. The disclosure makes use of this knowledge by detecting instability of the vehicle using at least the steering angle deviation. The actual steering angle can be easily determined in the driving situation. Conventional vehicle control systems, which are provided in almost all vehicles today, usually determine the steering angle anyway. It is therefore particularly easy to determine the steering angle in the method on the basis of signals and/or measured variables that are already available on the vehicle. The method is particularly easy to implement. The driving situation is preferably a situation in which the lateral dynamics of the vehicle change, such as cornering or an evasive maneuver. However, the driving situation can also involve the vehicle driving straight ahead, in which case the actual steering angle and the target steering angle are generally equal to zero and the steering angle deviation is also equal to zero.

The trajectory includes at least one planned driving path (target path) that is to be traveled by the vehicle to complete the driving task. The trajectory preferably includes the path to be traveled by the vehicle in the next calculation interval of the trajectory. This can preferably be the path to be traveled by the vehicle in the next few seconds. The trajectory is therefore preferably not a route for solving an entire driving task of the vehicle. For example, the trajectory for cornering includes at least one path bend along which the vehicle is to travel through the bend. The trajectory furthermore preferably includes a driving dynamics specification. This driving dynamics specification preferably is or includes a speed specified for traveling the path or a speed profile specified for traveling the driving path. The trajectory is planned for the driving situation before the actual driving situation, that is, it preferably describes a target value of the vehicle movement for the driving situation. The trajectory is preferably determined by a fully or semi-autonomous unit, such as an automatic distance control system or an autonomous control unit, also known as a virtual driver. The driving situation is not a discrete point in time, but a period of time. The driving situation includes at least one period of time that is required to achieve an effect on the vehicle position by adjusting an actual steering angle value.

The target steering angle is determined on the basis of the trajectory. The target steering angle is a forecast value of the steering angle for the trajectory, that is, a steering angle that must be steered according to a forecast on the vehicle in order to guide the vehicle along the trajectory. Preferably, the target steering angle is determined using at least one geometric characteristic. For this purpose, the method can include determining at least one geometric characteristic of the vehicle. The geometric characteristic at least partially represents a geometry of the vehicle. Additionally or alternatively to geometric dimensions, the at least one geometric characteristic can preferably also contain quantity specifications (for example, a number of axles of the vehicle). The geometric characteristic is in particular a geometric variable that defines the driving dynamics of the vehicle, such as a wheelbase of the vehicle, an axle spacing between axles of the vehicle, a track width of the vehicle, a distance between a rear axle of the vehicle and a coupling point of a trailer, and/or a configuration type of a trailer vehicle (for example, drawbar trailer or center-axle trailer). A configuration type of the trailer vehicle can also be taken into consideration or represented via a geometric characteristic. Preferably, the target steering angle is determined using the trajectory and the at least one geometric characteristic using a vehicle model. The vehicle model can be a single-track model of the vehicle, for example. In a particularly simple case, the target steering angle can be an Ackermann angle, which is determined from the path and a wheelbase of the vehicle. The Ackermann angle is the quotient of the wheelbase and a radius of curvature of the path, wherein the wheelbase of the vehicle forms the dividend and the radius of curvature forms the divisor. However, the target steering angle can also be determined on the basis of more complex relationships.

The target steering angle and the actual steering angle that is actually present in the driving situation are used to determine a steering angle deviation. The steering angle deviation indicates a deviation between the target steering angle and the actual steering angle. The steering angle tolerance value is provided in the method. Instability is detected if the steering angle deviation violates the steering angle tolerance value. The steering angle deviation violates the steering angle tolerance value if the steering angle deviation is outside a tolerance band, the width of which is determined by the steering angle tolerance value, around the target steering angle. For example, with a steering angle tolerance value of 2°, instability is detected earlier if the steering angle deviation has a value of ±2° or more. By taking the steering angle tolerance value into account, errors in determining the actual steering angle and/or the target steering angle can be compensated for and the method becomes more robust against error detection. Preferably, the steering angle tolerance value is defined using a model quality of a vehicle model used to determine the target steering angle.

Vehicle instability is preferably oversteer or understeer of the vehicle. Oversteer and understeer are common terms used to describe the driving behavior of vehicles. With understeer, it is necessary to steer harder to follow a bend than with a neutral vehicle. Oversteer of the vehicle is often colloquially described as the rear of the vehicle breaking away. It should be understood that the deviations recognized earlier in the method according to the disclosure and preferably reduced by driving dynamics interventions can affect driving conditions that can generally (still) be perceived as stable driving. In this way, even minor instabilities can be detected at an early stage, even if the driver still perceives the vehicle's driving behavior as stable. The instability can be determined on the basis of the trajectory (steering, position). The still “stable” driving is now preferably evaluated using the trajectory and preferably not exclusively on the basis of acceleration sensors.

The vehicle has one or more vehicle actuators which are intended to influence the driving dynamics of the vehicle. The driving dynamics include at least longitudinal dynamics and/or lateral dynamics of the vehicle. An example of a vehicle actuator is, for example, a drive motor of the vehicle, which is intended to accelerate the vehicle or to keep the speed of the vehicle constant against resistances acting on the vehicle. The drive motor therefore substantially influences the longitudinal dynamics of the vehicle. However, it may also be possible to influence the lateral dynamics of the vehicle via one or more drive motors of the vehicle, for example if only individual wheels of the vehicle are driven. A brake and/or braking system of the vehicle is another example of a vehicle actuator. It should be understood that the vehicle actuator brake system can also have several sub-actuators. For example, the brake system can have one brake actuator for each wheel of the vehicle.

The driving dynamics intervention is preferably used to stabilize the vehicle. The purpose of the method according to the disclosure is to improve the accuracy with which the vehicle follows an intended trajectory of a driver. For example, the vehicle's tendency to understeer can be greatly increased compared to normal driving behavior due to incorrect loading of the vehicle, so that a steering angle specified by the driver is not sufficient to drive along the intended trajectory. For example, a vehicle may tend to understeer due to a rear-heavy load or an articulated truck due to a high load on the kingpin. The method preferably improves the trajectory accuracy in such a way that the vehicle better follows the trajectory intended by the driver despite such inadequate steering input from the driver. Preferably, the vehicle can be stabilized with constant tractive force or constant drive torque.

The driving dynamics intervention is carried out using at least one vehicle actuator of the vehicle. However, several vehicle actuators can also be used as part of the driving dynamics intervention. The driving dynamics intervention is intended to counteract the instability of the vehicle. However, it should be understood that the driving dynamics intervention does not have to completely eliminate the instability. For example, understeer of the vehicle can be reduced but not completely eliminated by the driving dynamics intervention. For example, an instability can be counteracted by applying the brakes until the instability is eliminated by reducing the vehicle speed. The vehicle speed can be reduced, for example, by controlling a brake slip or by reducing the drive torque.

The method preferably furthermore includes: determining a vehicle position of the vehicle in the driving situation; and determining a target/actual deviation between the vehicle position and the trajectory. The vehicle position is the actual position of the vehicle in the driving situation. This vehicle position may deviate from a desired position of the vehicle on the path of the trajectory. This is particularly the case if the vehicle is unstable. For example, a yaw rate of the vehicle is too low in the event of understeer and the vehicle is carried out of a bend to be traveled. In this case, there is a target/actual deviation between the vehicle position and the trajectory or between the vehicle position and a target position corresponding to the path. This target/actual deviation can then be determined in the method. Preferably, the target/actual deviation is or includes a lateral deviation of the vehicle from a path encompassed by the trajectory. The lateral deviation is an offset of the vehicle or the vehicle position from the path transverse to the direction of travel of the vehicle. For a vehicle that understeers, such a lateral deviation is typically directed to the outside of the bend. A lateral deviation of the vehicle from the trajectory is particularly critical, as a lateral deviation to the center of the lane may lead to collisions with oncoming vehicles, while a lateral deviation to the outer edge of the lane may cause the vehicle to leave the lane. The space available is limited, especially for commercial vehicles. For example, for a commercial vehicle with a width of 2.5 m driving in the middle of a country road with a width of 3.5 m, there is only a free space of 0.5 m on each side to compensate for instabilities in good time. Preferably, the target/actual deviation is or includes a directional error of the vehicle with respect to a target orientation of the vehicle encompassed by the trajectory. The target alignment is an alignment of the vehicle intended within the framework of the trajectory, which is preferably defined with reference to the path. As a rule, the target alignment is selected so that the front of the vehicle points in the direction of the path. Preferably, the directional error is a float angle between a target alignment angle encompassed by the trajectory and an actual alignment angle present in the driving situation. A directional error is a strong indication of instability in the vehicle's driving dynamics and is therefore particularly suitable for use in the early detection of instability. For example, an understeering vehicle or its longitudinal axis with a tangent to the target path includes a float angle, as the yaw rate of the vehicle is too low to align the front of the vehicle along the bend. In the case of oversteer, however, the yaw rate of the vehicle is too high, causing the vehicle to turn into the bend more than intended. This also results in a directional error of the vehicle when oversteering.

According to a first embodiment, an intensity of the driving dynamics intervention is proportional to an amount of the target/actual deviation and/or an amount of the steering angle deviation. For large amounts of target/actual deviation and/or steering angle deviation, a driving dynamics intervention with high intensity is then carried out, while a target/actual deviation and/or steering angle deviation with a small amount results in a driving dynamics intervention with lower intensity. For example, if the driving dynamics intervention is or includes deceleration of the vehicle, then the vehicle is braked more strongly that is, with greater intensity) for a large amount of steering angle deviation of 10°, for example, than for a smaller amount of steering angle deviation of 2°. Similarly, the vehicle can be braked more strongly if there is a lateral deviation of 0.8 m from the path than if there is a lateral deviation of 0.2 m. By using the amount of the target/actual deviation or the steering angle deviation, the method can be used independently of a steering direction. However, it should be understood that the sign of the target/actual deviation and/or the steering angle can be used to determine the side or direction of the driving dynamics intervention. By scaling the intensity of the driving dynamics intervention in proportion to the amount of steering angle deviation, creeping deviations can be counteracted. This makes it possible to prevent erratic driving dynamics interventions that are perceived as unsafe.

In a preferred development, the method further includes providing a trajectory orientation tolerance value for the target/actual deviation, wherein early detection of instability of the vehicle only takes place if the determined steering angle deviation violates the steering angle tolerance value and the target/actual deviation violates the trajectory orientation tolerance value. The method then includes a further condition for the early detection of instability. Instability is therefore only detected if there is both a violation of the steering angle tolerance value due to the determined steering angle deviation and a violation of the trajectory orientation tolerance value due to the determined target/actual deviation. The risk of false detections of instabilities can be reduced. For example, errors in determining the target steering angle do not lead to early detection of instability if the actual steering angle corresponds to the steering angle actually required for the driving task and the vehicle follows the trajectory without any deviation between the target and actual values. The quality of the method and the robustness of the method against errors is increased. The trajectory orientation tolerance value is preferably violated if the vehicle position deviates from the trajectory by more than the trajectory orientation tolerance value. For a trajectory orientation tolerance value of 1 m, the trajectory orientation tolerance value is violated, for example, if the vehicle has a lateral deviation of 0.3 m to the path encompassed by the trajectory.

The method preferably furthermore includes: monitoring the target/actual deviation, wherein the target/actual deviation is determined continuously or at several successive points in time during the monitoring; determining a trajectory deviation change rate, wherein the early detection of an instability of the vehicle only takes place if the trajectory deviation change rate characterizes an increasing target/actual deviation of the vehicle position from the trajectory. The trajectory deviation change rate indicates the temporal change in the target/actual deviation, that is, the deviation of the vehicle position from the trajectory. The trajectory deviation change rate preferably describes the change in the trajectory deviation over a certain time period in relation to the duration of this time period. The time period under consideration is preferably short. The duration of the time period is preferably 10 sec. (seconds) or less, preferably 8 sec. or less, preferably 6 sec. or less, preferably 5 sec. or less, preferably 4 sec. or less, preferably 3 sec. or less, preferably 2 sec. or less, preferably 1 sec. or less, preferably 3 to 40 msec (milliseconds), particularly preferably 5 to 10 msec. An increasing target/actual deviation is an indication of instability. An increasing rate of change in trajectory deviation occurs, for example, if the vehicle understeers when cornering and, as a result, the lateral deviation of the vehicle increases steadily. Determining the trajectory deviation change rate makes it particularly easy to recognize deviations of an actual movement of the vehicle from a target movement according to the trajectory at an early stage. Starting from a state in which the vehicle is traveling on the path, the occurrence of even a small target/actual deviation causes an increasing trajectory deviation change rate. In this way, a trajectory deviation change rate can be determined even for small absolute target/actual deviations. By taking into account the trajectory deviation change rate in the method, the early detection of instability becomes more robust and the risk of false detections is minimized. For example, target/actual deviations resulting from the vehicle already entering a bend with a lateral deviation to the path, but then following the bend stably with the same lateral deviation to the path, cannot be taken into account.

According to an embodiment, the driving dynamics intervention at least partially compensates for the target/actual deviation. In this case, the method can preferably be carried out in such a way that the driver, who sets the actual steering angle different from the target steering angle, is not aware of the driving dynamics intervention. The handling of the vehicle can then appear particularly safe to the driver, as they do not have to deviate from their usual steering angle. If the driving dynamics intervention at least partially compensates for the target/actual deviation, the vehicle approaches the path. The risk of the vehicle colliding with objects next to the path is reduced. The driving dynamics intervention therefore preferably improves the safety of the vehicle not only by counteracting instability, but also by improving the positional accuracy of the vehicle. However, it should be understood that the same driving dynamics intervention can both compensate for the target/actual deviation and counteract instability.

Preferably, the method also includes terminating the driving dynamics intervention if the target/actual deviation reaches or falls below a position tolerance limit. In the embodiment, the driving dynamics intervention is terminated when the target/actual deviation has been reduced to such an extent that the position tolerance limit is reached or undershot. For example, a motor torque of a drive motor can only be limited until the lateral deviation of the vehicle from the path of the trajectory falls below a position tolerance limit of 0.3 m.

The method preferably furthermore includes: terminating the driving dynamics intervention if the steering angle deviation reaches or falls below a stability limit. The driving dynamics intervention can then be terminated, for example, when the driver of the vehicle notices the instability and compensates for it by adjusting the actual steering angle. In the event of an understeering vehicle, for example, the driving dynamics intervention is terminated when the driver increases the actual steering angle and thus approaches the target steering angle in order to compensate for the understeer. Due to the preferred development of the method, the driving behavior of the vehicle can be perceived as particularly intuitive. It should be understood that the driving dynamics intervention can already be terminated in variants if only the steering angle deviation reaches or falls below the stability limit or if only the target/actual deviation reaches or falls below the position tolerance limit. However, it is also possible that the driving dynamics intervention is only terminated if both the steering angle deviation reaches or falls below the stability limit and the target/actual deviation reaches or falls below the position tolerance limit. The driving dynamics intervention can therefore preferably only be terminated if the two criteria described above are present cumulatively.

In an embodiment of the method, providing a steering angle tolerance value for the steering angle deviation includes: determining at least one geometric characteristic of a current vehicle configuration of the vehicle; determining at least one load characteristic of the current vehicle configuration; defining the steering angle tolerance value for the target/actual deviation using the geometric characteristic and the load characteristic. In the preferred development the disclosure makes use of the finding that the transverse dynamic stability behavior of the vehicle is significantly influenced by the present vehicle configuration. In addition to geometric characteristics, load characteristics also have a significant influence on the stability behavior of the vehicle. The load characteristic represents loads acting at least partially on the vehicle, which can result, for example, from the intrinsic weight of the vehicle and from a cargo of the vehicle. Thus, a current vehicle configuration of an unloaded vehicle is different from a current vehicle configuration of the same vehicle in the loaded state. A load characteristic can preferably be or include a wheel load, an axle load, a total vehicle mass, a mass of part of the vehicle and/or a location of a center of mass of the vehicle or of part of the vehicle. Furthermore, the load characteristics can preferably also include data which represent a wheel load, an axle load, a total vehicle mass, and/or a mass of part of the vehicle. By defining the steering angle tolerance value using the geometric characteristic and the load characteristic, the current vehicle configuration can be taken into account. For example, the steering angle tolerance value can be defined as comparatively small or narrow if the load characteristic represents a rear-loaded vehicle, which generally tends to become unstable more quickly than a centrally loaded vehicle.

Preferably, the driving dynamics intervention is a braking intervention on one or more wheel brakes of the vehicle, an engine torque limitation of an engine of the vehicle, a provision of asymmetrical drive torques on wheels of the vehicle and/or a provision of an assisting steering torque via a steerable rear axle of the vehicle. Preferably, the driving dynamics intervention is carried out using a vehicle actuator that is different from a steering system of the vehicle on which the actual steering angle is set in the driving situation. The vehicle actuator is preferably suitable for applying a yaw moment to the vehicle. Preferably, the intensity of the braking intervention is proportional to the target/actual deviation. For example, the greater the lateral deviation of the vehicle from the path, the more powerful the braking can be.

The method preferably furthermore includes: determining a steering oscillation using a time history of the actual steering angle; and in response to detecting a steering oscillation: reducing the steering angle tolerance value if a steering oscillation is determined that lies within a natural frequency band of the vehicle. Preferably, the method includes determining the natural frequency band, which is particularly preferably based on a vehicle model of the vehicle. In cases where there is a steering oscillation on the vehicle that lies within a natural frequency band around a natural frequency of the vehicle, there is a risk that the steering oscillation or the resulting excitation of the vehicle will lead to a resonance of the vehicle. In this case, it is advantageous to lower the steering angle tolerance value or reduce the tolerance. By reducing the steering angle tolerance value, even small deviations in the steering angle lead to early detection of instability. For example, instability with a reduced steering angle tolerance value can already be detected with a steering angle deviation of 1°, whereas only a steering angle deviation of 2° leads to early detection of instability if no steering oscillation is detected or the detected steering oscillation is not within the natural frequency band of the vehicle.

In one preferred development, the method includes: determining an actual articulation angle between a towing vehicle and a trailer vehicle of the vehicle; determining a target articulation angle using the trajectory; and reducing the steering angle tolerance value if the actual articulation angle exceeds the target articulation angle by an articulation angle tolerance value. A target articulation angle is preferably determined using a vehicle model, in particular a single-track model of the vehicle. The vehicle model can include one or more load characteristics and one or more geometric characteristics of the vehicle. An actual articulation angle that exceeds the target articulation angle for a driving situation is a strong indication that the trailer vehicle is unstable. For example, the articulation angle can be used to determine whether the trailer vehicle is being pushed open, also known as jackknifing, or whether the trailer vehicle is breaking away. Both are very critical and dangerous situations that can be detected at an early stage by determining the actual articulation angle, which is preferably permanently compared with the target articulation angle, which is preferably determined on the basis of a model calculation. If, for example, the trailer vehicle is empty and the towing vehicle is loaded in such a driving situation, it is very likely that the driver of the towing vehicle will not notice anything because the towing vehicle remains completely stable. In the preferred development, the safety of the method can be improved, as even relatively small steering angle deviations lead to early detection of instability.

In a second aspect, the disclosure solves the problem mentioned at the outset with a driver assistance system for improving a trajectory orientation of a vehicle, which is configured to carry out the method according to the first aspect of the disclosure. Preferably, the driver assistance system includes a control unit and an interface that can be connected to a vehicle network of the vehicle. The interface is preferably configured to receive vehicle signals that represent at least the trajectory, the expected steering angle value, the actual steering angle value and/or the manipulated variable deviation. Furthermore, the vehicle signals can also represent the load characteristics. It should be understood that one or more of the determination steps of the method may be performed by the driver assistance system on the basis of such vehicle signals. The driver assistance system therefore does not have to determine the load characteristics directly itself, for example, but can also determine them on the basis of load signals provided by the vehicle's air suspension system on the vehicle network.

In a third aspect, the disclosure solves the problem mentioned at the outset by a vehicle having at least two axles, an autonomous unit, a steering system, and a driver assistance system according to the second aspect of the disclosure.

According to a fourth aspect of the disclosure, the problem mentioned at the outset is solved via a computer program product which has program code means which are stored on a computer-readable data carrier in order to carry out the method according to the first aspect of the disclosure when the computer program product is executed on a computing unit, in particular the control unit of the driver assistance system according to the second aspect of the disclosure.

It should be understood that the driver assistance system according to the second aspect of the disclosure, the vehicle according to the third aspect of the disclosure and the computer program product according to the fourth aspect of the disclosure have the same and similar sub-aspects.

### BRIEF DESCRIPTION OF DRAWINGS

The invention will now be described with reference to the drawings wherein:

FIG. 1 shows a plan view of a schematically depicted vehicle;

FIG. 2A shows a driving situation of the vehicle according to FIG. 1, illustrated as cornering, with the vehicle understeering;

FIG. 2B shows a driving situation of the vehicle according to FIG. 1, illustrated as cornering, with the vehicle oversteering;

FIG. 3 shows a schematic flow chart of a method for controlling the vehicle;

FIG. 4 shows a graph which illustrates, for a driving situation, a progression of an actual steering angle, a target steering angle, a curvature of a path, a lateral deviation of the vehicle and a directional error of the vehicle, wherein no driving dynamics intervention takes place;

FIG. 5 shows a representation analogous to FIG. 4, wherein only part of the driving situation is illustrated and a driving dynamics intervention is made to counteract instability; and,

FIG. 6 shows a schematic flow chart further illustrating the provision of a steering angle tolerance value of the method according to FIG. 4.

### DETAILED DESCRIPTION

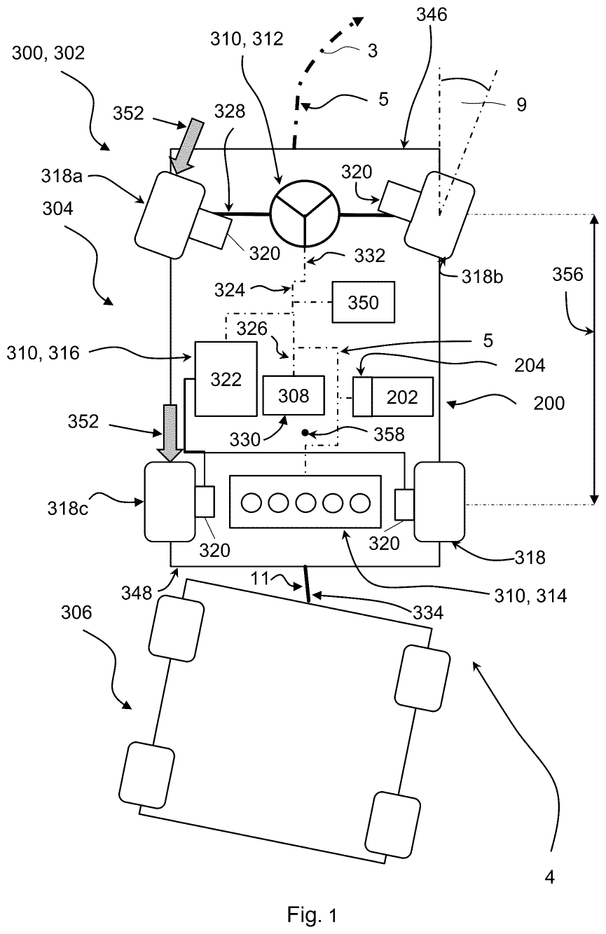

FIG. 1 shows a vehicle 300, which is configured here as a vehicle train 302. The vehicle train 302, which is a commercial vehicle, includes a towing vehicle 304 towing a trailer vehicle 306. An autonomous unit 308, also referred to as a virtual driver, is provided to control the vehicle 300 and is adapted to perform trajectory planning to obtain a trajectory 3 for the vehicle 300. The trajectory 3 includes a path 5 to be traveled by the vehicle 300. The vehicle 300 should follow this path 5 according to the trajectory 3.

The vehicle 300 includes as vehicle actuators 310 an electronically controllable steering system 312, a drive motor 314 and a braking system 316. The braking system 316 is provided for decelerating wheels 318 of the vehicle 300. For this purpose, the brake system 316 has brake actuators 320 assigned to the wheels 318. The brake actuators 320 are sub-actuators of the vehicle actuator 310 formed by the brake system 316 and control a brake slip of the wheels 318. This brake slip corresponds to a brake pressure provided at the brake actuators 320, which is provided by a brake modulator 322 of the brake system 316. The autonomous unit 308 of the vehicle 300 is connected to the brake modulator 322 via a vehicle network 324, which in this case is a CAN bus, and provides brake signals 326 to it. The brake modulator 322 receives the brake signals 326 from the autonomous unit 308 and controls corresponding brake pressures for the brake actuators 320. It should be understood that the brake pressures provided for the different wheels 318 may vary. A brake pressure at a left front wheel 318a of a front axle 328 of the vehicle 300 may therefore be different from a brake pressure provided at the brake actuator 320 associated with a right front wheel 318b of the vehicle 300. Furthermore, the brake system 316 is also provided for decelerating the trailer vehicle 306, wherein only brake actuators 320 of the towing vehicle 304 are shown in FIG. 1.

The autonomous unit 308 of the vehicle 300 shown in FIG. 1 is also configured as a position controller 330. The autonomous unit 308 controls the vehicle 300 in a regular driving situation along the path 5 encompassed by the trajectory 3. For this purpose, the autonomous unit 308 controls the drive motor 314, the braking system 316 and the electronically controllable steering system 312 such that the vehicle 300 follows the path 5 at a target speed 7 encompassed by the trajectory 3, wherein the target speed 7 may vary along the path 5 or may represent a speed profile. In addition to the braking system 316 and the autonomous unit 308, the vehicle network 324 also interconnects the electronically controllable steering system 312 and an engine control unit of the drive engine 314, which is not shown in FIG. 1. To control the vehicle 300, the autonomous unit 308 provides signals on the vehicle network 324, which can then be received by the other units of the vehicle 300.

The electronically controllable steering system 312 receives steering signals 332 provided by the autonomous unit 308 and steers the vehicle 300 according to these steering signals 332. For this purpose, the electronically controllable steering system 312 controls an actual steering angle 9 at the front wheels 318a, 318b of the towing vehicle 304 corresponding to the steering signals 332 provided by the autonomous unit 308. Simultaneously, the autonomous unit 308 controls the longitudinal acceleration of the vehicle 300 by sending corresponding signals to the drive motor 314 and the braking system 316.

The towing vehicle 304 and the trailer vehicle 306 are connected via a drawbar 334, wherein the trailer vehicle 306 here does not include its own drive and is pulled by the towing vehicle 304. The trailer vehicle 306 follows the towing vehicle 304, wherein an actual articulation angle 11 is established between the towing vehicle 304 and the trailer vehicle 306. When traveling in a stationary straight line, the actual articulation angle 11 has a value of 0°, since the trailer vehicle 306 is traveling straight behind the towing vehicle 304.

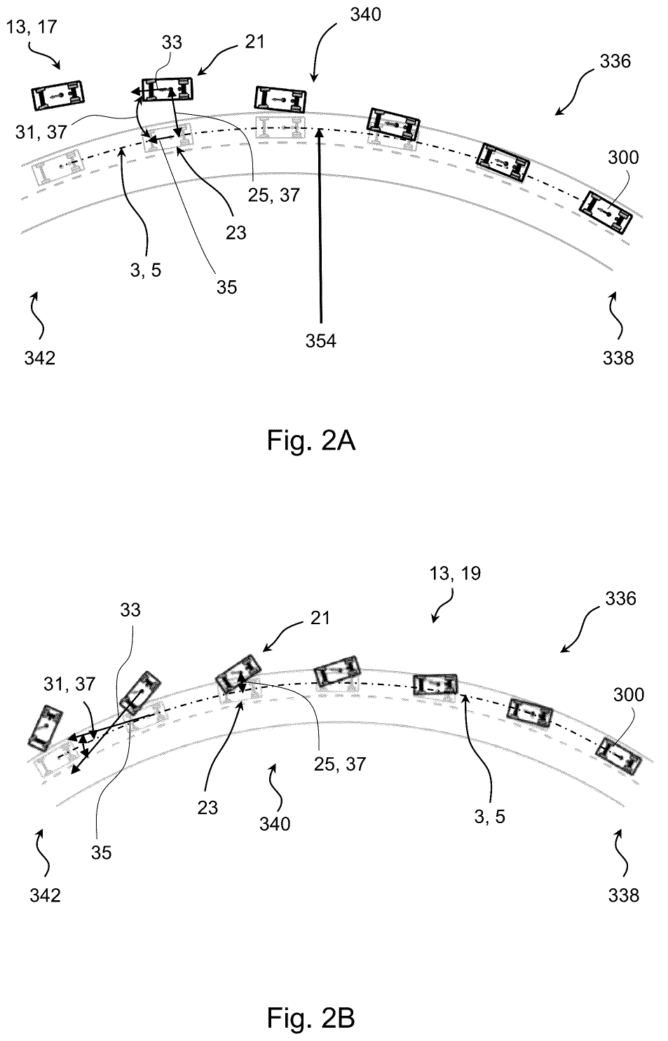

During stable driving, only the virtual driver 308 controls the fully autonomous vehicle 300 shown in FIG. 1. In certain situations, however, the vehicle 300 may become unstable or exhibit deviating driving behavior that does not correspond to the driving behavior assumed in the trajectory planning. This is often the case if the vehicle 300 is loaded unfavorably. An unfavorable load is present, for example, if the trailer vehicle 306 is fully loaded while the towing vehicle 304 is empty. In this case, the vehicle 300 tends to be unstable, as the trailer vehicle 306 can push the towing vehicle 304 from behind. Furthermore, a deviation between the assumed driving behavior and a real driving behavior can exist, for example, if a loading situation of a trailer vehicle 306 configured as a semitrailer leads to an increased rear axle load of a towing vehicle 304 configured as a tractor unit and thus causes understeering driving behavior. Furthermore, poor road conditions, such as slippery roads or reduced friction between the wheels 318 of the vehicle 300 and a road surface 334 (see FIGS. 2A, 2B) due to an oil slick, sand or chippings, can result in the vehicle 300 being unable to follow the path 5 encompassed by the trajectory 3.

Two types of instability 13 that can occur in a driving situation 15 are understeer 17 and oversteer 19 of the vehicle 300. FIG. 2A and FIG. 2B illustrate the driving situation 15 as a cornering movement of the vehicle 300, wherein only the towing vehicle 304 is shown for simplification. FIG. 2A and FIG. 2B illustrate these unstable driving conditions using a simplified vehicle 300. FIG. 2A shows understeer 17 of the vehicle 300, while FIG. 2B illustrates oversteer 19 of the vehicle 300. In FIG. 2A and FIG. 2B, the instability 13 (understeer 17 or oversteer 19) is superimposed on a stable driving state in which the vehicle 300 ideally follows the path 5. The vehicle 300 ideally following the path 5 of the trajectory 3 is shown in FIG. 2A and FIG. 2B with a lower contrast. When entering the bend 336 shown, a vehicle position 21 of the vehicle 300 is still substantially identical to a target position 23 of the vehicle 300 on the trajectory 3 or its path 5 when the instability 13 is present.

In FIG. 2A, the vehicle 300 travels through the bend 336 from right to left. A bend entry 338 is thus shown near the right edge of the image, while a bend exit 342 is arranged near the left edge of the image. A bend apex 340 of the bend 336 lies between the bend entry 338 and the bend exit 342. In the unstable case, the vehicle 300 cannot follow the course of the bend 336, which in this case is the course of the trajectory 3. At understeer 17, the vehicle 300 deviates to the outside of the bend from the planned path 5, which corresponds exactly to the course of the bend 336. A lateral deviation 25 of the vehicle 300 relative to the path 5 or trajectory 3 increases continuously from the bend entry 338 to the bend exit 342. An actual yaw rate 27 of the vehicle 300 is lower than a target yaw rate 29, so that the vehicle 300 turns less into the bend 336 than is required to follow the trajectory 3. A directional error 31 between an actual alignment 33 of the vehicle 300 in the vehicle position 21 and a target alignment 35 of the stably moving vehicle 300 also increases towards the bend exit 340. Here the directional error 31 is a float angle of the vehicle 300. In the embodiment shown, a multidimensional target/actual deviation 37 between the vehicle position 21 and the trajectory 3 therefore occurs during cornering. On the one hand, the vehicle position 21 in the form of the lateral deviation 25 deviates from the target position 23 transversely to a direction of travel 344 illustrated by an arrow and, on the other hand, the actual alignment 33 of the vehicle position 21 differs from the target alignment 35.

FIG. 2B illustrates an oversteering vehicle 300. When oversteering 19 occurs, the vehicle 300 turns in more than would be necessary to follow the path 5 of the trajectory 3. Even if the actual steering angle 9 of the vehicle 300 is smaller than a target steering angle 39, or even points in the opposite direction, the actual yaw rate 27 of the vehicle 300 during oversteer 19 exceeds the target yaw rate 29 required to ideally follow the bend 336. The directional error 31 also increases continuously during oversteer 19 from bend entry 338 to bend exit 342, but has a different sign compared to understeer 17. Thus, a front 346 of the vehicle 300 points further inwards into the bend when oversteering 19 than when the vehicle 300 is driving stably, whereas the front 346 of the vehicle 300 points further outwards into the bend when understeering 17 than when the vehicle 300 is driving stably. Due to the excessive actual yaw rate 27 compared to the target yaw rate 29, a rear 348 of the vehicle 300 breaks away during oversteer 19. In the embodiment shown in FIG. 2B, a lateral deviation 25 of the vehicle 300 also increases towards the outside of the bend.

In extreme cases, the autonomous unit 308 keeps the actual steering angle 9 constant and does not adapt it to the driving situation 15 despite the presence of the target/actual deviation 37. In general, however, the autonomous unit 308, which is configured as a position controller 330, monitors the vehicle position 21 of the vehicle 300. As soon as the autonomous unit 308 detects a significant target/actual deviation 37, the autonomous unit 308 attempts to return the vehicle 300 to the path 5 of the trajectory 3 via appropriate control interventions. However, the autonomous unit 304 does not fully achieve this here. In the event of understeer 17 (see FIG. 2A), the autonomous unit 308 increases the actual steering angle 9 all the faster the greater the lateral deviation 25 of the vehicle 300. As soon as this adjustment of the actual steering angle 9 by the autonomous unit 308 exceeds a predefined rate of change, a stability control system 350 of the vehicle 300 intervenes to stabilize it. The stability control system 350 here is an Electronic Stability Control (ESC), which is connected to the vehicle network 324 (see FIG. 1). The ESC provides brake signals 326 on the vehicle network 324 that cause the braking system 316 of the vehicle 300 to apply brake pressure to the brake actuators 320 associated with the inside wheels of the vehicle 300. The brake actuators therefore decelerate the wheels on the inside of the bend. For the bend 336 according to FIG. 2A, the wheels on the inside of the bend are a left front wheel 318a and a left rear wheel 318c of the vehicle 300. The delay is illustrated by arrows 352 in FIG. 1. In the case of oversteer 19 (see FIG. 2B), on the other hand, a front wheel on the outside of the bend, which for the left-hand bend 336 according to FIG. 2B is a right-hand front wheel 318b of the vehicle, is preferably decelerated.

The stability control system 350 is an emergency system that only intervenes in the driving operation of the vehicle 300 when very large instabilities occur. The stability control system 350 interprets a control requirement from the driver's steering request and a measured vehicle movement. The driver therefore has the task of converting the instability 13 detected by him into a steering request in such a way that the stability control system 350 supports him in reducing the instability 13. ESC interventions in stable driving conditions must be avoided, as these would significantly impair the safety of the vehicle 300 and could lead to accidents. An intervention threshold of the stability control system 350 is therefore selected so high that only major instabilities of the vehicle 300 lead to an intervention of the stability control system 350 (ESC). The high intervention thresholds of the stability control system 350 mean that a stabilizing intervention of the stability control system 350 only occurs late, so that the vehicle 300 can already have a very large lateral deviation 25 to the path 5 of the trajectory 3 when the stability control system 350 intervenes. The late intervention of the stability control system 350 therefore entails the risk that the vehicle may leave the road 334 and/or collide with an obstacle due to the increased space required. The ESC also intervenes late in the event of oversteer 19, as incorrect interventions, which can result from measurement errors for example, must be avoided. If no other system is provided, the virtual driver 308 is responsible for recognizing a target/actual deviation 37 at an early stage.

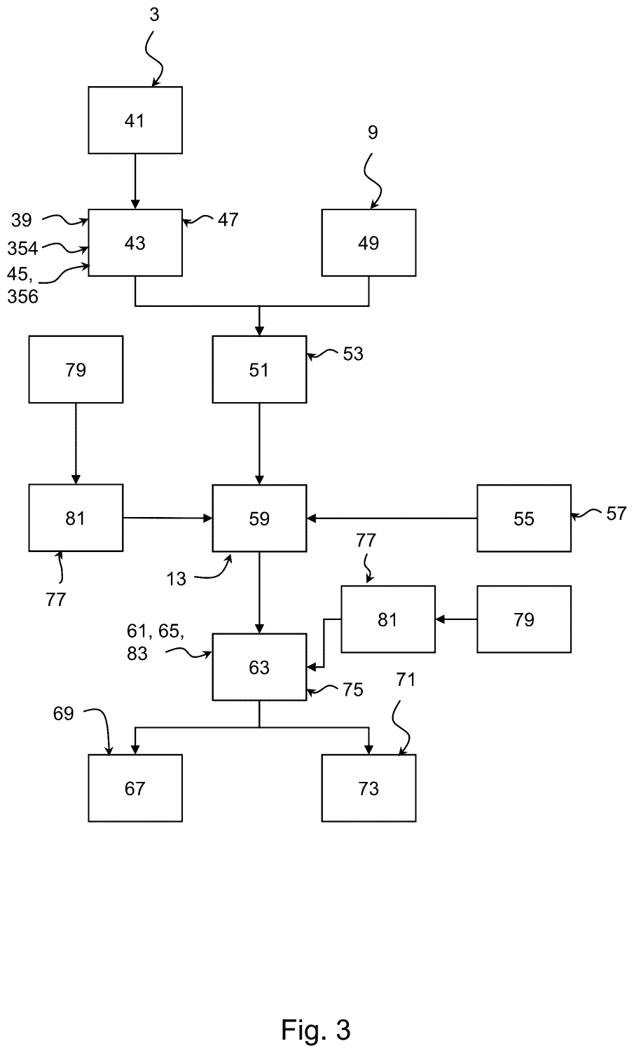

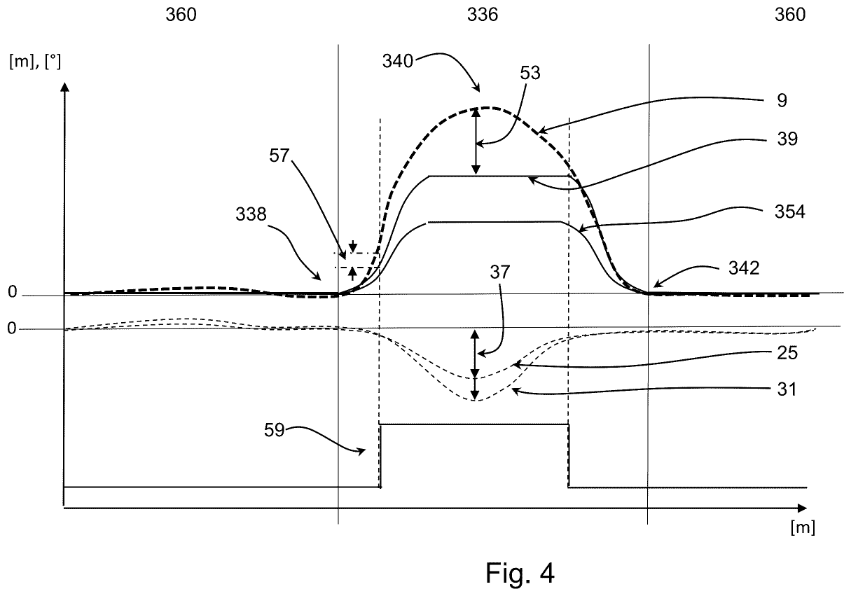

The vehicle 300 therefore additionally includes a driver assistance system 200, which is intended for the early detection of instability 13. The driver assistance system 200 has a control unit 202, which is also connected to the vehicle network 324 via an interface 204. The control unit 202 is configured to provide braking signals 326 for the braking system 316 and steering signals 332 on the vehicle network 324. Furthermore, the control unit 202 of the driver assistance system 200 receives the trajectory 3 provided by the autonomous unit 308 on the vehicle network 324. In alternative variants, however, the driver assistance system 200 or its control unit 202 can also be part of the autonomous unit 308. The driver assistance system 200 is configured to carry out the vehicle control method 1 explained below with reference to FIG. 3 and FIG. 4.

In a first step of the method 1, the driver assistance system 200 determines the trajectory 3 provided on the vehicle network 324 as part of a determination 41. Using the trajectory 3, the control unit 202 determines the target steering angle 39 in a subsequent step (determination 43 in FIG. 3). For the driving situation 15 illustrated in FIG. 2A, the control unit 202 first determines a radius of curvature 354 of the trajectory 3, which is indicated in simplified form as an arrow in FIGS. 2A and 2B. Furthermore, the control unit 202 determines a wheelbase 354 of the towing vehicle 304. From this, the control unit 202 calculates an Ackermann angle as the target steering angle 39 by dividing the wheelbase 356 by the radius of curvature 354. In the embodiment shown, the target steering angle 39 is therefore determined on the basis of the radius of curvature 354 resulting from the driving task to be performed. Furthermore, the control unit 202 also takes into account a geometric characteristic 45, namely the wheelbase 356, when determining 43 the target steering angle 39. Vehicle-specific aspects are also taken into account in the determination 43. The Ackermann angle is a simple example used for illustration purposes to determine 43 the target steering angle 39. In other variants of the method 1, however, more complex relationships can also be taken into account to determine 43 the target steering angle 39. Preferably, the determination 43 is further based on a load characteristic 47 of the vehicle 300. Such a load characteristic 47 is illustrated in FIG. 1 as the position of a center of gravity 358 of the towing vehicle 304. The center of gravity 358 of the towing vehicle 304 is shifted towards the rear 348 due to unfavorable loading of the vehicle 300 in a current vehicle configuration 4, so that the vehicle 300 tends to understeer 17. By using the load characteristic 47 to determine 43 the target steering angle 39, a quality of the determination 43 can preferably be improved. The target steering angle 39 predicted during determination 43 is closer to a steering angle that must be set so that the vehicle 300 ideally follows the path 5.

In the driving situation 15, the autonomous unit 308 steers the vehicle 300 by providing the steering signals 332 on the vehicle network 324. In the driving situation 15, that is, while the vehicle 300 is driving through the bend 336 in the embodiment shown in FIG. 2A, the actual steering angle 9 is thus controlled at the steered front wheels 318a, 318b of the vehicle 300. In addition to the steering 312, the control unit 202 also receives the steering signals 332 and uses them to determine 49 the actual steering angle 9 actually controlled in the driving situation 15. From the determined actual steering angle 9 and the previously determined target steering angle 39, the control unit 202 determines a steering angle deviation 53 between the target steering angle 39 and the actual steering angle 9 in a further step of the method, which is shown in FIG. 3 as determination 51. The steering angle deviation 53 is determined here simply as the difference between the target steering angle 39 and the actual steering angle 9.

During a subsequent provision 55, a steering angle tolerance value 57 corresponding to the steering angle deviation 53 is provided. In this case, the provision 55 occurs only after the determination 51 of the steering angle deviation 53. However, it should be understood that the steering angle tolerance value 57 can also be provided before determination 51 of the steering angle deviation 53, determination 49 of the actual steering angle 9, determination 43 of the target steering angle 39 and/or determination 41 of the trajectory 3. The provided steering angle tolerance value 57 and the determined steering angle deviation 53 are then used by the control unit 202 in an early detection 6 of an instability 13 of the vehicle 300. In the driving situation 15 illustrated in FIG. 2A, the actual steering angle 9 of the vehicle 300 is too small to follow the course of the bend 336 from the bend entry 338 to the bend exit 342. Via the method 1 described above, the control unit 202 is able to detect the occurring instability 13, which in FIG. 2A is the understeer 17 of the vehicle 300, at an early stage.

FIG. 4 illustrates in detail a progression of a curvature of the path 5, the target steering angle 39, the actual steering angle 9, the lateral deviation 25 and the directional error 31 along the course of the bend 336 during the driving situation 15, with the vehicle 300 traveling along a straight section 360 before and after the bend 336. The curvature of the path 5 is the inverse of the radius of curvature 354. The bend entry 338 and the bend exit 342 are marked in FIG. 4, wherein the curvature of the path 5 or the bend 336 before the bend entry 338 and after the bend exit 342 is zero. In the straight section 360 before the bend 336, the actual steering angle 9 and the target steering angle 39 are also approximately zero. The lateral deviation 25 and the directional error 31 of the vehicle 300 are also approximately zero in the straight section 360 before the bend 336. Small fluctuations in the lateral deviation 25 and the directional error 31 in the straight sections 360 result from error determinations of the vehicle position 21 and, if necessary, corrections of the autonomous unit 308. At the bend entry 336, the actual steering angle 9 increases approximately uniformly with the target steering angle 39. The autonomous unit 308 uses the steering 312 to control the actual steering angle 9 in order to guide the vehicle 300 along the path 5. As already described, however, the autonomous unit 308 does not succeed in doing this in the event of understeer 17 as shown in FIG. 2A, resulting in a target/actual deviation 37. This target/actual deviation 37 is characterized here by the increasing lateral deviation 25 starting from the bend entry 338 and the directional error 31. Since the actual steering angle 9 corresponding to the target steering angle 39 is not sufficient to guide the vehicle along the path 5, the autonomous unit 308 increases the actual steering angle 9 via the steering 312 so that a steering angle deviation 53 occurs. Due to the increased actual steering angle 9, the vehicle 300 can follow the course of the bend 336 better and the target/actual deviation 37 between the vehicle position 21 and the path 5 of the trajectory 3 decreases towards the bend exit 342. The actual steering angle 9 can be reduced so that the steering angle deviation 53 between bend apex 340 and bend exit 342 is also reduced. In contrast to the driving situation 15 shown in FIG. 2A, the vehicle 300 is again correctly aligned on the path 5 at the exit 342 of the bend, so that the lateral deviation 25 and the directional error 31 have a value of approximately zero. Increasing the actual steering angle 9 by the autonomous unit 308 was therefore sufficient here to steer the vehicle 300 through the bend 336, wherein there were considerable target/actual deviations 37 in the meantime.

FIG. 4 also illustrates the early detection 59 of instability 13. As soon as the steering angle deviation 53 is greater than the steering angle tolerance value 57, the control unit 202 detects an impending instability 13. The comparison between the steering angle tolerance value 57 and the steering angle deviation 53 is based on the amount. The method 1 can be used both for the left-hand bend 336 shown and for right-hand bends. The instability 13 of the vehicle 300 can be determined at an early stage, although only a small target/actual deviation 37 has occurred during early detection 59 (rising flank of the progression shown in FIG. 4). The control unit 202 can thus detect the instability 13 at an early stage.

Without additional intervention by the driver assistance system 200, the target/actual deviation 37 nevertheless assumes considerable values, as the autonomous unit 308 in the example shown in FIG. 4 only reacts to the target/actual deviation 37, which only assumes values that cause the autonomous unit 308 to react after the early detection 59. Safe operation of the vehicle 300 is at risk. The control unit 202 is therefore configured to execute a driving dynamics intervention 61 (execution 63 in FIG. 3) in response to the early detection 59 of the instability 13 (of the understeer 17 in FIG. 2A). The driving dynamics intervention 61 is a braking intervention 65 in the present embodiment. During braking intervention 65, the wheels on the inside of the bend (wheels 318a, 318c in FIG. 1) are braked for understeer 17. Preferably, the rear wheel 318c on the inside of the bend is braked in particular, as this can prevent feedback effects on the steering 312 of the vehicle 300. To carry out the braking intervention 65, the control unit 202 of the driver assistance system 200 provides corresponding braking signals 326 on the vehicle network 324. The brake modulator 322 then controls a brake slip on the wheels 318 on the inside of the bend via the brake actuators 320. The braking intervention 65 can be illustrated analogously to a control system intervention of the stability control system 350 by the arrows 352, but takes place earlier. The braking intervention 65 or the resulting deceleration of the wheels 318 on the inside of the bend causes a yaw moment of the vehicle 300 in the direction of the bend 336, which at least partially compensates for the directional error 31.

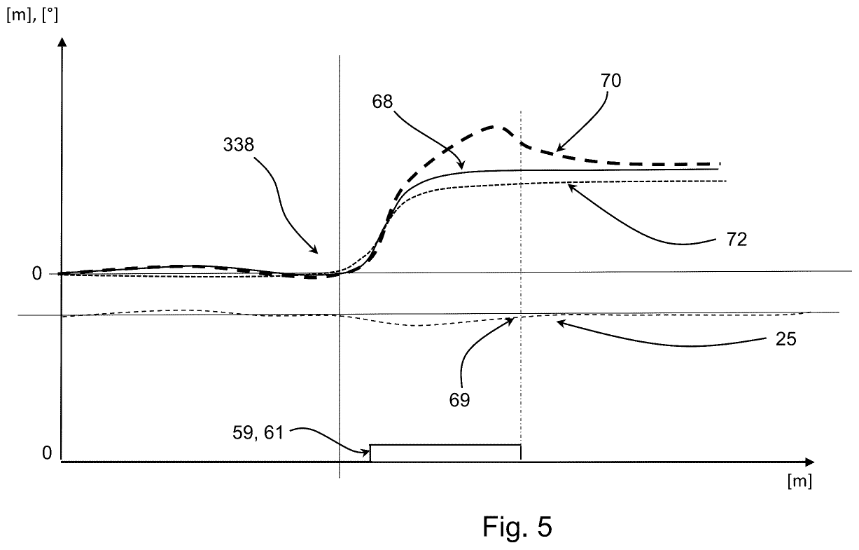

FIG. 5 illustrates the effect of the braking intervention 65 on a vehicle 300, as it tends to understeer 17 when negotiating the bend 336. FIG. 5 shows a progression 68 of the actual steering angle 9, which must be controlled on the vehicle 300 when the driving dynamics intervention 61 is carried out in the driving situation 15. In addition, FIG. 5 shows a reference bend 70 of the actual steering angle for the case in which the vehicle 300 is guided along the path 5 by the steering 312 alone (that is, a driving situation 15 without driving dynamics intervention 61). The progression 68 of the actual steering angle 9 with driving dynamics intervention 61 is very close to a kinematic steering angle 72 of a neutral vehicle 300 that neither understeers nor oversteers. At substantially the same time as the early detection 59, the control unit 202 initiates the braking intervention 65 or the execution 63 of the driving dynamics intervention 61, whereby the understeer 17 is compensated. As a result of the braking intervention 65, an additional yaw moment is generated for the vehicle 300 so that the actual steering angle 9 is sufficient to guide the vehicle 300 along the path 5. Compared to the driving situation 15 without driving dynamics intervention 61 (FIG. 4), the course of the lateral deviation 25 is considerably flatter for the driving situation 15 with braking intervention 65. As a result of the driving dynamics intervention 61, there is therefore considerably less lateral deviation 25, which results in an increase in safety. Preferably, an intensity of the braking intervention 65 is proportional to an amount of the target/actual deviation 37. For example, the greater the lateral deviation 25 of the vehicle 300 from the path 5, the more strongly the wheels 318 on the inside of the bend can be braked in the event of understeer 17.

The target/actual deviation 37 is compensated or equalized by the driving dynamics intervention 61. FIG. 5 therefore also illustrates a termination 67 of the driving dynamics intervention 61, which is carried out as soon as the target-actual deviation 37 reaches a position tolerance limit 69. The braking action 65 is terminated here as soon as the lateral deviation 25 reaches the position tolerance limit 69. However, the driving dynamics intervention 61 can also be terminated if the steering angle deviation 53 reaches a stability limit 71. This termination 73 is also illustrated in FIG. 3.

In preferred variants of the method 1, the early detection 59 only takes place if, in addition to the steering angle deviation 53 exceeding the steering angle tolerance value, there is also a target/actual deviation 37 which violates a trajectory orientation tolerance value 75. Furthermore, it may be provided that the early detection 59 only takes place if a trajectory deviation change rate 77, which characterizes the temporal course of the target/actual deviation 37, characterizes an increasing target/actual deviation 37, as is the case in FIG. 4 between bend entry 338 and bend apex 340. In the present embodiment, the autonomous unit 308 continuously provides signals on the vehicle network 324 representing the vehicle position 21. Based on these signals, the control unit 202 monitors 79 the target/actual deviation 37 and determines 81 the trajectory deviation change rate 77. By additionally taking into account the trajectory orientation tolerance value 75 and the trajectory deviation change rate 77, which are also illustrated in FIG. 3, error determinations of instabilities 13 can be prevented.

Although the method 1 was explained above for understeer 17 of the vehicle 300, it should be understood that a target/actual deviation 37 of the vehicle 300 in the driving situation 15 can also be reduced for oversteer 19 or an evasive maneuver of the vehicle 300. When oversteering 19 occurs, the braking intervention 65 preferably decelerates the front wheel of the vehicle 300 on the outside of the bend, which is the right front wheel 318b of the vehicle 300 for the left-hand bend as shown in FIG. 2B. Furthermore, in addition to or as an alternative to the braking intervention, an engine torque limitation 83 can also be carried out, for example, in which an engine torque that can be provided by the drive motor 314 of the vehicle 300 is limited.

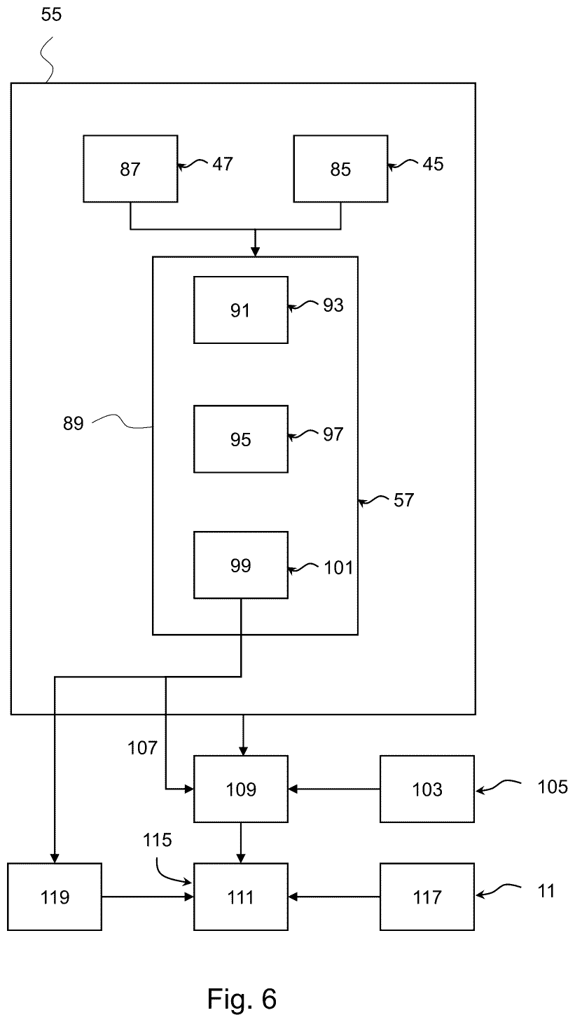

FIG. 6 further illustrates the provision 55 of the steering angle tolerance value 57, which in the embodiment shown includes determining 85 at least one geometric characteristic 45 of the current vehicle configuration 4, determining 87 a load characteristic 47 of the current vehicle configuration 4, and defining 89 the steering angle tolerance value 57 using the geometric characteristic 45 and the load characteristic 47. To define 89 the steering angle tolerance value 57, the control unit 202 of the driver assistance system 200 here determines a mass distribution 93 of the vehicle 300 in a determination 91 using a plurality of load characteristics 47 and a plurality of geometric characteristics 45. The control unit 202 uses the mass distribution 93 and the geometric characteristics 45 to model 95 the vehicle 300 in the current vehicle configuration 4. During the modeling 95, the control unit 202 generates an individualized vehicle model 97 of the vehicle 300 from a basic vehicle model, wherein the geometric characteristics 45, the load characteristics 47 and the mass distribution 93 are parameters of the model. The model then uses the control unit 202 to make a prediction 99 of dynamic properties 101 of the vehicle 300, which the control unit 202 then uses to define 89 the steering angle tolerance value 57.

After the provision 55, the steering angle tolerance value 57 is available. This can be used directly for the early detection 59 of instability 13. In preferred embodiments, however, it can also be provided that the steering angle tolerance value 57 is adjusted depending on other parameters before it is compared with the steering angle deviation 53 during early detection 59 of an instability 13. In the embodiment shown in FIG. 5, a steering oscillation 105 is determined 103 for this purpose. The control unit 202 of the driver assistance system 200 monitors the actual steering angle 9 over time for this purpose. The dynamic properties 101 of the vehicle 202 also include natural frequency bands 103 of the vehicle 300. If the determined steering oscillation 105 is within one of the determined natural frequency bands 103, then the control unit 202 executes a reduction 109 of the steering angle tolerance value 57. The steering angle tolerance value 57 is reduced during the reduction 107 so that instability 13 is detected earlier. Preferably, a warning signal can be output and/or a driving dynamics intervention can be carried out if the determined steering oscillation 105 lies within one of the determined natural frequency bands 103.

The steering angle tolerance value 57 can also be reduced (reduction 111 in FIG. 6) if the actual articulation angle 11 exceeds a target articulation angle 113 by an articulation angle tolerance value 115. The actual articulation angle 11 and the target articulation angle 113 are determined in advance for this purpose. To determine 117 the actual articulation angle 11, the control unit 202 uses articulation angle signals provided by an articulation angle sensor on the vehicle network 324, which is not shown in the figures. The determination 119 of the target articulation angle 113 is also carried out by the control unit 202, wherein this is based on the dynamic properties 101 of the vehicle 300 determined during the prediction 99. After the reduction 109 and the reduction 111, the steering angle tolerance value 57 is used for early determination 59. Instabilities 13 of the vehicle 300 can thus be detected even earlier.

The method 1 was explained above by way of illustration using the control unit 202 of the driver assistance system 200. However, it should be understood that the method 1 need not be performed by the control unit 202. In particular, the method 1 or individual steps of the method 1 may also be performed by the autonomous unit 308, a main control unit of the vehicle 300 or a steering control unit of the steering system 312.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Vehicle control method
3 Trajectory
4 Present vehicle configuration
5 Path
7 Target speed
9 Actual steering angle
11 Actual articulation angle
13 Instabilities
15 Driving situation
17 Understeer
19 Oversteer
21 Vehicle position
23 Target position
25 Lateral deviation
27 Actual yaw rate
29 Target yaw rate
31 Directional error
33 Actual alignment
35 Target alignment
37 Target/actual deviation
39 Target steering angle
41 Determination of the trajectory
43 Determination of the target steering angle
45 Geometric characteristic
47 Load characteristic
49 Determination of the actual steering angle
51 Determination of a steering angle deviation
53 Steering angle deviation
55 Provision of a steering angle tolerance value
57 Steering angle tolerance value
59 Early detection of an instability
61 Driving dynamics intervention
63 Execution of the driving dynamics intervention
65 Braking intervention
67 Termination of the driving dynamics intervention when a position tolerance limit is reached
68 Progression of the actual steering angle in a driving situation in which a driving dynamics intervention is carried out
69 Position tolerance limit
70 Reference progression of the actual articulation angle for the driving situation without driving dynamics intervention
71 Stability limit
72 Kinematic steering angle
73 Termination of the driving dynamics intervention when a stability limit is reached
75 Trajectory orientation tolerance value
77 Trajectory deviation change rate
79 Monitoring of the target/actual deviation
81 Determination of the trajectory deviation change rate
83 Motor torque limitation
85 Determination of a geometric characteristic
87 Determination of a load characteristic
89 Definition of the steering angle tolerance value
91 Determination of a mass distribution
93 Mass distribution
95 Modeling
97 Vehicle model
99 Prediction of dynamic properties
101 Dynamic properties
103 Determination of a steering oscillation
105 Steering oscillation
107 Natural frequency band
109 Reduction of the steering angle tolerance value as a result of steering oscillation
111 Reduction of the steering angle tolerance value as a result of an excessive articulation angle
113 Nominal articulation angle
115 Articulation angle tolerance value
117 Determination of the actual articulation angle
119 Determination of the target articulation angle
200 Driver assistance system
202 Control unit
204 Interface
300 Vehicle
302 Vehicle train
304 Towing vehicle
306 Trailer vehicle
308 Autonomous unit
310 Vehicle actuators
312 Steering system
314 Drive motor
316 Braking system
318 Wheels
318a Left front wheel
318b Right front wheel
318c Left rear wheel
320 Brake actuator
322 Brake modulator
324 Vehicle network
326 Brake signals
328 Front axle
330 Position controller
332 Steering signals
334 Drawbar
336 Bend
338 Bend entry
340 Bend apex
342 Bend exit
344 Direction of travel
346 Front
348 Rear
350 Stability control system
352 Delay
354 Radius of curvature
356 Front axle of the towing vehicle
358 Center of gravity of the towing vehicle
360 Straight section

1. A method for controlling a vehicle in a driving situation, the method comprising:
determining a trajectory of the vehicle for the driving situation;
determining a target steering angle on the basis of the trajectory;
determining an actual steering angle of the vehicle in the driving situation;
determining a steering angle deviation between the determined target steering angle and the determined actual steering angle;
providing a steering angle tolerance value for the steering angle deviation;
providing early detection of instability of the vehicle when the determined steering angle deviation violates the steering angle tolerance value; and,
in response to the early detection of the instability of the vehicle, executing at least one vehicle dynamics intervention using at least one vehicle actuator of the vehicle to counteract the instability of the vehicle.

2. The method of claim 1, further comprising:
determining a vehicle position of the vehicle in the driving situation; and,
determining a target/actual deviation between the vehicle position and the trajectory.

3. The method of claim 2, wherein an intensity of the driving dynamics intervention is proportional to an amount of the target/actual deviation.

4. The method of claim 2, further comprising:
providing a trajectory orientation tolerance value for the target/actual deviation; and,
wherein the early detection of an instability of the vehicle only takes place when the determined steering angle deviation violates the steering angle tolerance value and the target/actual deviation violates the trajectory orientation tolerance value.

5. The method of claim 3, further comprising:
monitoring the target/actual deviation, wherein the target/actual deviation is determined continuously or at several successive points in time during monitoring; and,
determining a trajectory deviation change rate, wherein the early detection of the instability of the vehicle only takes place when the trajectory deviation change rate characterizes an increasing target/actual deviation of the vehicle position from the trajectory.

6. The method of claim 3, wherein the driving dynamics intervention at least partially compensates for the target/actual deviation.

7. The method of claim 6, further comprising terminating the driving dynamics intervention when the target/actual deviation reaches or falls below a position tolerance limit.

8. The method of claim 1, furthermore comprising terminating the driving dynamics intervention when the steering angle deviation reaches or falls below a stability limit.

9. The method of claim 1, wherein the provision of the steering angle tolerance value for the steering angle deviation comprises:
determining at least one geometric characteristic of a current vehicle configuration of the vehicle;
determining at least one load characteristic of the current vehicle configuration; and,
defining the steering angle tolerance value for the target/actual deviation using the geometric characteristic and the load characteristic.

10. The method of claim 1, wherein the driving dynamics intervention is a braking intervention on one or more wheel brakes of the vehicle, an engine torque limitation of an engine of the vehicle, and wherein at least one of the following applies: i) a provision of asymmetrical drive torques on wheels of the vehicle; and, ii) a provision of an assisting steering torque via a steerable rear axle of the vehicle.

11. The method of claim 1, furthermore comprising:
determining a steering oscillation using a time history of the actual steering angle; and,
in response to the determination of a steering oscillation, reducing the steering angle tolerance value when the steering oscillation is determined which lies in a natural frequency band of the vehicle.

12. The method of claim 1, furthermore comprising:
determining an actual articulation angle between a towing vehicle and a trailer vehicle of the vehicle;
determining a target articulation angle using the trajectory; and,
reducing the steering angle tolerance value when the actual articulation angle exceeds the target articulation angle by an articulation angle tolerance value.

13. A driver assistance system for improving a trajectory orientation of a vehicle in a driving situation, comprising:
a control unit, wherein the driver assistance system is configured to carry out a method including the following method steps:
determining a trajectory of the vehicle for the driving situation;
determining a target steering angle on the basis of the trajectory;
determining an actual steering angle of the vehicle in the driving situation;
determining a steering angle deviation between the determined target steering angle and the determined actual steering angle;
providing a steering angle tolerance value for the steering angle deviation;
providing early detection of instability of the vehicle when the determined steering angle deviation violates the steering angle tolerance value; and,
in response to the early detection of the instability of the vehicle, executing at least one vehicle dynamics intervention using at least one vehicle actuator of the vehicle to counteract the instability of the vehicle.

14. A vehicle having at least two axles, the vehicle comprising a driver assistance system configured to carry out a method including the following method steps:
determining a trajectory of the vehicle for the driving situation;
determining a target steering angle on the basis of the trajectory;
determining an actual steering angle of the vehicle in the driving situation;
determining a steering angle deviation between the determined target steering angle and the determined actual steering angle;
providing a steering angle tolerance value for the steering angle deviation;
providing early detection of instability of the vehicle when the determined steering angle deviation violates the steering angle tolerance value; and,
in response to the early detection of the instability of the vehicle, executing at least one vehicle dynamics intervention using at least one vehicle actuator of the vehicle to counteract the instability of the vehicle.

15. A computer program product comprising:
a program code stored on a non-transitory computer-readable medium, said program code being configured, when executed by a processor, to carry out a method for controlling a vehicle in a driving situation, the method including:
determining a trajectory of the vehicle for the driving situation;
determining a target steering angle on the basis of the trajectory;
determining an actual steering angle of the vehicle in the driving situation;
determining a steering angle deviation between the determined target steering angle and the determined actual steering angle;
providing a steering angle tolerance value for the steering angle deviation;
providing early detection of instability of the vehicle when the determined steering angle deviation violates the steering angle tolerance value; and,
in response to the early detection of the instability of the vehicle, executing at least one vehicle dynamics intervention using at least one vehicle actuator of the vehicle to counteract the instability of the vehicle.
